(19) United States
(12) Patent Application Publication
(10) Pub. No.: US 2013/0243357 A1
(43) Pub. Date: Sep. 19, 2013

(54) Torque support for integrated hoisting machine

(71) Applicants: Wolfgang Schubert, Netphen (DE); Klaus Hofmann, Netphen (DE)

(72) Inventors: Wolfgang Schubert, Netphen (DE); Klaus Hofmann, Netphen (DE)

(73) Assignee: Siemag Tecberg GmbH, Haiger (DE)

(21) Appl. No.: 13/883,852

(22) PCT Filed: Jun. 21, 2011
(86) PCT No.: PCT/EP2011/060344

§ 371 Date: May 9, 2013

(30) Foreign Application Priority Data
Nov. 8, 2010 (GB) 1018805.0

(51) Int. Cl. F16C 17/02

(52) U.S. Cl. CPC F16C 17/02
USPC 384/416

(57) ABSTRACT

Device for bearing the stator shaft of an integrated hoisting machine, with a pedestal for carrying the hoisting loads and a torque support (20) for carrying the turning load, wherein the torque support (20) consists of at least one separate torque block (30, 40) for each turning direction of the hoisting machine, each having a bearing opening (36) with a cross section of flat bearing surfaces, angled with respect to each other, for receiving a bearing section of the stator shaft with a corresponding cross section.

This invention generally relates to integrated hoisting machines. In particular, the invention relates to a device for bearing the stator shaft of an integrated hoisting machine.

As commonly known in the art, the stator of an integrated hoisting machine is connected to a shaft. This shaft then is fixed to a foundation by means of a pedestal to carry the hoisting loads into the foundation.

The torque support transmits the load of the haulage cables or wire ropes via a portion of the stator shaft having a round cross section and a corresponding bore in the pedestal. The occurring righting moment or reaction is transmitted by means of a polyhedral form-fit connection between a bearing section of the stator shaft and a torque support that is connected to the pedestal. For that purpose the stator shaft is provided with a polyhedral, usually square, section at its end portions which is fixed free from backlash in the torque support with a corresponding polyhedral bearing opening.

Consequently, the torque is mostly transmitted generally via the edges. Initially only a line contact may be established at the peripheral diameter of the bearing section. Only after deformation of the edges, the compression across the edges is reduced to a surface pressure corresponding to the material strength. As a result, permanent deformation may occur at the bearing section of the shaft. Such permanent deformation may also result from various dynamic stress situations which are difficult to predetermine

As this bearing section has to transmit the motor torque in two turning directions (two directions of motion), alternating stress causes deformation on both sides and thus, a play leading to minor rotational movements of the bearing section within the corresponding bearing opening. These rotational movements may result in a malfunction of the machine.

There is therefore a clear need to improve the device for bearing the stator shaft of an integrated hoisting machine.

### SUMMARY OF THE INVENTION

Considering all of the above, one objective of the present invention is, to provide a torque support for an integrated hoisting machine, avoiding deformation and rotational movement of the stator shaft as in the prior art.

This and other objectives can be achieved by providing a device for bearing the stator shaft of an integrated hoisting machine, with at least one separate torque block for each turning direction of the hoisting machine, so that excessive deformation and clearance of the stator shaft due to alternating loads of the hoisting machine can be avoided.

The separate torque blocks for each turning direction may be provided independently from the pedestal or may be connected to the pedestal. Furthermore, they may rest on the same foundation as the pedestal in question or on separate foundations, and can be individually adjusted for eliminating a possible backlash.

Preferably, each torque support is provided with a bearing opening, having a cross section of flat bearing surfaces, angled with respect to each other, for receiving a bearing section of the stator shaft with a corresponding cross section, whereby the dimensions of the bearing opening are larger than the dimensions of the bearing section of the stator shaft to be received therein, and whereby on at least part of the bearing surfaces of the bearing opening pressure elements are provided, bridging the gap between the bearing surfaces of the bearing opening and the corresponding bearing surfaces of the bearing section of the stator shaft to be received.

Furthermore, the pressure elements may be fixed to the bearing surfaces in a removable manner, to allow replacement of the pressure elements due to wear.

Additionally, the pressure elements may be adjustable in their thickness in a way that allows them to contact the surfaces of the bearing portion throughout, avoiding line contact between the pressure elements and the corresponding contact surfaces within the bearing opening. In other words, the bearing clearance between the bearing portion of the stator shaft and the bearing opening can be adjusted.

Preferably, the connection by form-fit between the shaft and the torque support is free from backlash. The adjustment of the pressure elements may either be performed manually or automatically by an adjustment mechanism comprised in the torque support.

Every torque block may be designed as a rigid plate made out of a suitable material, preferably steel, with the receiving bearing opening of each torque extending across the thickness of the respective plate.

Furthermore, at least two plates may be provided in a stack per bearing section of the stator shaft to be received, in order to allow an adjustment to the respective load conditions.

Each bearing opening can furthermore be offset from the middle of the respective torque block. In particular, every opening in each plate may be offset sideways from the middle in opposite directions per plate, with the stack of plates being arranged in such a manner that the openings in the plates are in alignment and the centre lines of the bearing openings and bearing section coincide.

If more than one torque block is provided per bearing section, the at least two torque blocks that are stacked together are connected by at least one common base element, to which the torque blocks are fixed.

The cross sections of the bearing section and of the bearing opening preferably have a polyhedral shape, more preferably a square cross section.

### BRIEF DESCRIPTION OF THE DRAWINGS

Referring now to the attached drawing which forms part of this original disclosure:

FIG. 1 is a perspective front view of the torque support according to a preferred embodiment.

### DETAILED DESCRIPTION OF THE PREFERRED EMBODIMENT

A preferred embodiment of the present invention will now be explained with reference to the drawings. It will be apparent to those skilled in the art from this disclosure that the following description of the embodiment of the present invention is provided for illustration purposes only and not for the purpose of limiting the invention as defined by the appended claims and their equivalents.

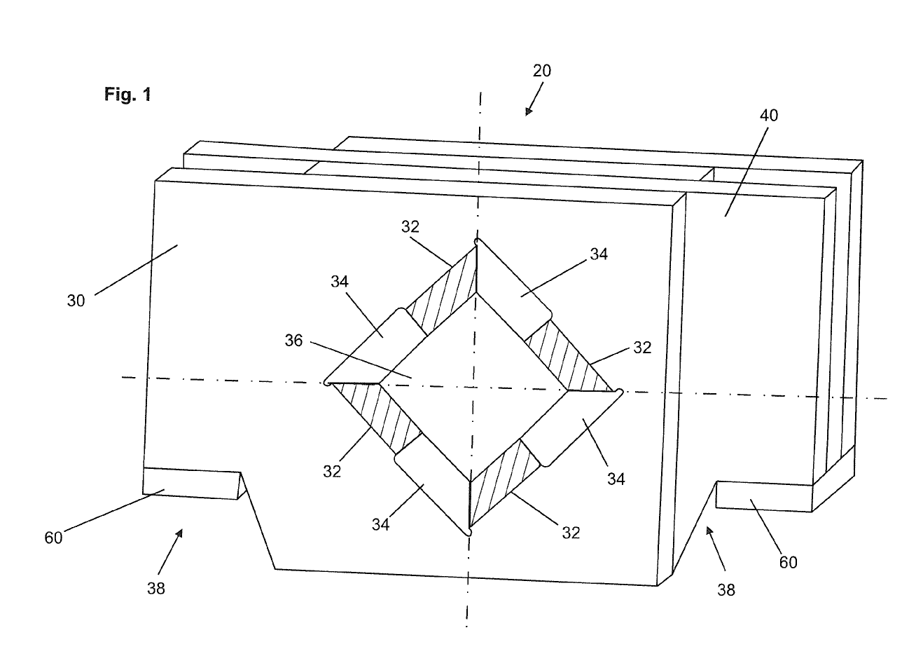

Referring now to FIG. 1, a torque support 20 for an integrated hoisting machine (not shown) is illustrated. The torque support 20 comprises a torque block 30 for a counter clockwise acting load direction of the hoisting machine 1, a torque block 40 for a clockwise acting load direction of the integrated hoisting machine 1 and two corresponding base elements 60 for the two load directions to which the torque blocks 30 and 40 are fixed.

The two torque blocks 30 and 40 have the exact same design but are disposed within the torque support 20 rotated by 180° with respect to each other. In other words the torque support 20 only consists of one type of torque block but in the torque support 20 the blocks are arranged facing alternating directions. Also, as can be taken from the drawing, all the centre lines of the bearing openings coincide.

In the following, the description only refers to one torque block 30 for a counter clockwise acting load direction of the hoisting machine, but it should be understood from this description as well as from the drawing that all the features of torque block 30 apply to torque block 40 as well.

The torque block 30 is a rigid plate-type member made out of a suitable material, preferably steel. The torque block 30 may have a rectangular shape. In the current embodiment the torque block 30 has a rectangular shape with a recess 38 at one corner of the torque block 30. The recess is meant to receive the base element 60 therein. Hence, the surfaces of all stacked torque blocks comprised in the torque support for contacting the base element of one load direction are coplanar.

A bearing opening 36 extends through the torque block 30. This bearing opening 36 has a square cross section. The opening is spaced apart from the middle of the plate in an opposite direction with respect to the recess 38. The bearing opening 36 has a square cross section corresponding to a square cross section of the stator shaft to be received therein.

Within the bearing opening 36 four pressure elements 32 are disposed. The four pressure elements 32 have a cuboid type form and are made of a suitable material, preferably a metal softer than the stator shaft and/or the torque block. In the present invention one of the two face surfaces is angled. The pressure elements 32 have planar contact with the torque block.

When the stator shaft is placed within the bearing opening 36 the pressure elements 32 have planar contact therewith as well. The pressure elements 32 preferably do not project from the torque block they are attached to, such that the torque blocks may be stacked without a gap in between.

As shown in FIG. 1 each one of the contacting surfaces of the bearing opening 36 is divided into two sections. One is meant for receiving the corresponding pressure element and the other section is meant as a free-cut 34 to avoid direct contact between the stator shaft and the torque block 30 as well as facilitate the insertion of the stator shaft into the bearing opening 36 in case of the replacement of one or a plurality of torque blocks 30.

Another reason for the shape shown in FIG. 1 of the free-cut 34 is to allow controlling of the following torque block 30 with its pressure elements 32 towards the inside of the stack. Since alternating torque blocks 30 form the torque support 20, a pressure element 32 for a specific load direction is followed by a gap and then again by a pressure element 32 of the same load direction, if seen across the stack.

The pressure elements 32 are replaceable and adjustable in their thickness or position with respect to the torque block 30 they are attached to, respectively. The adjustability can be achieved by means of a threaded connection between the pressure elements 32 and the torque block 30 or by tapered pieces. Thus, by regular control of the bearing clearance and a corresponding adjustment of the thickness of the pressure element 32 or a replacement thereof in case of wear, a continuously planar contact between the pressure element 32 and the stator shaft can be maintained. Any backlash that may develop can be compensated.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While only one embodiment has been chosen to illustrate the present invention, it will be apparent to those skilled in the art from this disclosure that various changes and modifications can be made herein without departing from the scope of the invention as defined in the appended claims. Furthermore, the foregoing description of the embodiment according to the present invention is provided for illustration only, and not for the purpose of limiting the invention as defined by the appended claims and their equivalents.

1. Device for bearing the stator shaft of an integrated hoisting machine, with a pedestal for carrying the hoisting loads and a torque support for carrying the turning load, wherein the torque support consists of at least one separate torque block for each turning direction of the hoisting machine, each having a bearing opening with a cross section of flat bearing surfaces, angled with respect to each other, for receiving a bearing section of the stator shaft with a corresponding cross section.

2. Device according to claim 1, wherein the dimensions of the bearing opening are larger than the dimensions of the bearing section of the stator shaft to be received therein, and that on at least part of the bearing surfaces of the bearing opening pressure elements are provided, bridging the gap between the bearing surfaces of the bearing opening and the corresponding bearing surfaces of the bearing section of the stator shaft to be received.

3. Device according to claim 1, wherein the separate torque blocks for each turning direction are provided independently from the pedestal.

4. Device according to claim 1, wherein the torque blocks rest on foundations separate from those of the respective pedestal.

5. Device according to claim 1, wherein the pressure elements are fixed to the bearing surfaces in a removable manner, to allow replacement of the pressure elements.

6. Device according to claim 1, wherein the pressure elements are adjustable in thickness.

7. Device according to claim 1, wherein the torque blocks are made as plates, with the opening extending across the thickness of the respective plate.

8. Device according to claim 5, wherein at least two plates that are stacked together are provided per bearing section of the stator shaft to be received.

9. Device according to claim 6, wherein the opening in each plate is offset sideways from the middle in opposite directions per plate, with the stack of plates being arranged in such a manner that the openings in the plates are in alignment.

10. Device according to claim 7, wherein the at least two plates stacked together are kept together by at least one common base element.

11. Device according to claim 1, wherein the opening in each torque block is square in cross section for receiving a bearing section of the stator shaft to be received with a corresponding square cross section.

12. Device according to claim 2, wherein the separate torque blocks for each turning direction are provided independently from the pedestal.
